(19) United States
(12) Patent Application Publication
(10) Pub. No.: US 2024/0428036 A1
(43) Pub. Date: Dec. 26, 2024

(54) SMART CARD

(71) Applicant: KONA I CO., LTD., Seoul (KR)

(72) Inventors: Seung Gie LEE, Seoul (KR); Hyo Won YANG, Gwangmyeong-si, Gyeonggi-do (KR)

(21) Appl. No.: 18/279,119

(22) PCT Filed: Dec. 14, 2022
(86) PCT No.: PCT/KR2022/020394

§ 371 Date: Aug. 28, 2023

(51) Int. Cl. G06K 19/07; G06K 19/077

(52) U.S. Cl. CPC G06K 19/0707; G06K 19/0775; G06K 19/07773

(57) ABSTRACT

Provided is a smart card including: first and second antennas performing wireless communication with a card reader; a smart card chip electrically connected to the first antenna and performing the wireless communication with the card reader through the first antenna; a power generation unit converting a frequency signal received through the second antenna to generate direct current power, and an application circuit unit receiving the direct current power from the power generation unit and having at least one passive element operating under the control of the smart card chip, wherein one end of the at least one passive element of the application circuit unit is electrically connected to the power generation unit and the other end thereof is electrically connected to any one of a plurality of GPIO terminals of the smart card chip.

### TECHNICAL FIELD

The present invention relates to a smart card, and more specifically, to a smart card having double antennas.

### BACKGROUND ART

A smart card, which is called an NFC card, IC card, or the like, is classified into a contact card and a contactless card according to communication methods with a card reader. The contactless card means a card having radio frequency communication with the card reader through a wireless antenna embedded therein.

The contactless smart card, which is positioned at a close distance to the card reader, is recognized by the card reader through a radio frequency signal, and accordingly, the card reader and the smart card perform information exchange with each other by means of the radio frequency signal. The smart card allows the power for operating an integrated circuit (IC) chip embedded therein to be supplied by means of electronic coupling of a wireless antenna and communicates with the card reader by means of electromagnetic induction.

Further, the smart card includes an application circuit for providing other application functions except the smart card chip, such as information displaying functions using a display unit, visual notification functions using light emitting elements, audible notification functions using a speaker, and the like. If the smart card performs data communication with the card reader and receives power therefrom through a single antenna, however, synchronization errors may occur in the communication process between the smart card chip and the application circuit, an amount of power supplied may be not sufficient, and malfunctions may happen in the communication process between the application circuit and the smart card chip and in the RF communication process between the smart card and the card reader.

### DISCLOSURE

### Technical Problem

Accordingly, it is an object of the present invention to provide a smart card having double antennas that is capable of providing various application functions controlled by a smart card chip at a relatively low cost, increasing an amount of power received from a card reader, and improving the stability in the RF communication process with the card reader.

The technical problems to be achieved through the present invention are not limited as mentioned above, and other technical problems not mentioned herein will be obviously understood by one of ordinary skill in the art through the following description.

### Technical Solution

A smart card according to the present invention may include: a first and a second antennas performing wireless communication with a card reader; a smart card chip electrically connected to the first antenna and performing the wireless communication with the card reader through the first antenna; a power generation unit converting a frequency signal received through the second antenna to generate direct current power, and an application circuit unit receiving the direct current power from the power generation unit and having at least one passive element operating under the control of the smart card chip, wherein one end of the at least one passive element of the application circuit unit is electrically connected to the power generation unit and the other end thereof is electrically connected to any one of a plurality of GPIO terminals of the smart card chip.

A high level power terminal of the power generation unit may be electrically connected to one end of the at least one passive element, and a low level power terminal of the power generation unit may be electrically connected to another GPIO terminal.

The smart card chip may include: a plurality of transistors electrically connected to the plurality of GPIO terminals, and a virtual ground terminal electrically connected to source terminals of the plurality of transistors.

The virtual ground terminal may have a voltage equal to a voltage of the low level power terminal of the power generation unit under the control of the smart card chip.

Drain terminals of the plurality of transistors may be electrically connected to the plurality of GPIO terminals, and gate terminals of the plurality of transistors may be electrically connected to a control module embedded in the smart card chip to generate control signals according to pre-stored logics.

The plurality of transistors may be turned on by means of the control signals inputted to the gate terminals thereof.

The plurality of transistors may include a first transistor electrically connected to the at least one passive element and a second transistor electrically connected to the power generation unit, and the at least one passive element may operate if the first transistor and the second transistor are turned on.

The at least one passive element may be at least one of a light emitting element, an acoustic element, and a vibration module.

The smart card may further include a power storage unit electrically connected to the power generation unit and storing the direct current power generated from the power generation unit.

The application circuit unit may include an additional application circuit for generating an activation signal for activating the smart card chip.

The smart card may further include a contact terminal coming into contact with the card reader to receive power therefrom and allowing data communication between the smart card chip and the card reader.

Details of the smart card according to the embodiments of the present invention will be explained in the description and drawings.

### Advantageous Effects

According to the present invention, the smart card can provide various application functions controlled by the smart card chip at a relatively low cost, increase an amount of power received from the card reader, and improve the stability in the RF communication process with the card reader.

The effectiveness of the invention is not limited as mentioned above, and it should be understood to those skilled in the art that the effectiveness of the invention may include another effectiveness as not mentioned above from the detailed description of the present invention.

### BRIEF DESCRIPTION OF DRAWINGS

FIG. 1 is a schematic circuit diagram showing a smart card according to one embodiment of the present invention.

FIG. 2 is a schematic circuit diagram showing an application circuit unit of the smart card according to the present invention.

FIGS. 3 and 4 are schematic circuit diagrams showing GPIO terminals of a smart card chip according to the present invention.

FIG. 5 is a schematic circuit diagram showing an application circuit unit of a smart card according to another embodiment of the present invention.

FIG. 6 is a schematic circuit diagram showing a smart card according to yet another embodiment of the present invention.

### MODE FOR INVENTION

Objects, characteristics and advantages of the present invention will be more clearly understood from the detailed description as will be described below and the attached drawings. Before the present invention is disclosed and described, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure.

The corresponding parts in the embodiments of the present invention are indicated by corresponding reference numerals. The shapes, sizes, percentages, angles, and numbers of parts shown in the attached drawings are just exemplary, and therefore, the present invention may not be limited thereto.

Terms, such as the first, the second, A, and B, may be used to describe various elements, but the elements should not be restricted by the terms. The terms are used to only distinguish one element from the other element. For example, a first element may be named a second element without departing from the scope of the present invention. Likewise, a second element may be named a first element.

Hereinafter, embodiments of the present invention will be described in detail with reference to the attached drawings.

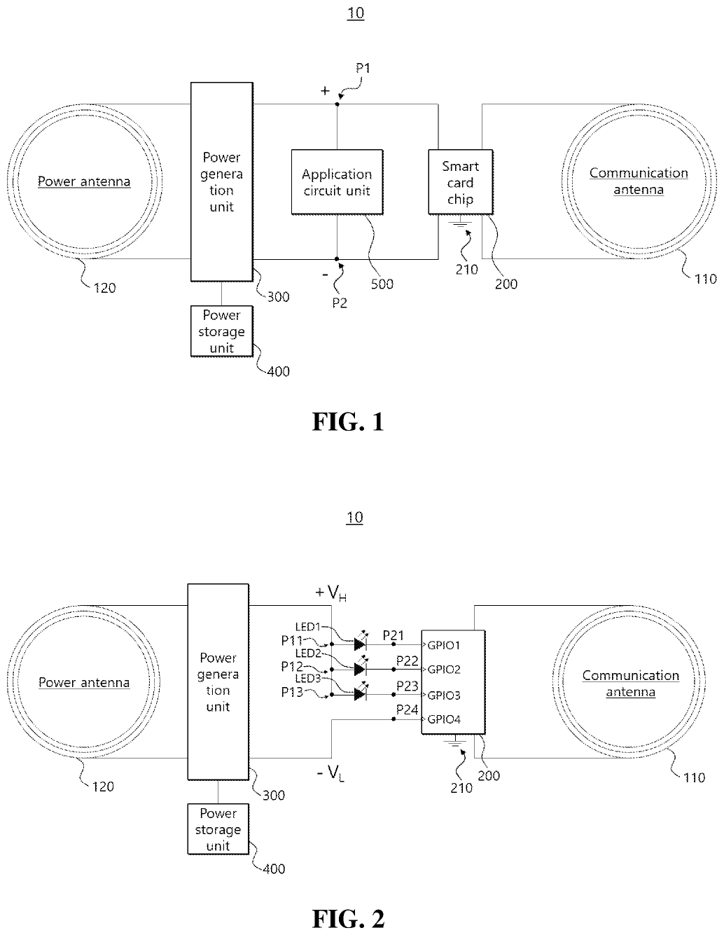

FIG. 1 is a schematic circuit diagram showing a smart card according to one embodiment of the present invention.

The smart card 10 according to one embodiment of the present invention includes a plurality of antennas 110 and 120, a smart card chip 200, a power generation unit 300, a power storage unit 400, and an application circuit unit 500. In the specification, the embodiment of the present invention in which the smart card 10 includes two antennas as the plurality of antennas 110 and 120 is provided, but the present invention may not be limited thereto. For example, the smart card 10 may include three or more antennas as the plurality of antennas 110 and 120, and according to the technical scope of the present invention, a method for synchronizing (that is, setting and controlling a ground voltage to the same values as one another) circuits connected to the three or more antennas may be applied.

The plurality of antennas 110 and 120 perform wireless communication with an external card reader (not shown). For example, the plurality of antennas 110 and 120 perform data communication with the external card reader by using wireless communication such as near field communication (NFC), radio-frequency identification (RFID), and the like through a communication module (not shown). The plurality of antennas 110 and 120 include the first antenna (e.g., a communication antenna) 110 and the second antenna (e.g., a power antenna) 120.

The first antenna 110 is electrically connected to the smart card chip 200 and serves as means performing the wireless communication between the smart card chip 200 and the external card reader. That is, the smart card chip 200 and the card reader have data communication with each other through the first antenna 110.

The second antenna 120 serves as means receiving power from the card reader wirelessly. For example, the second antenna 120 transmits an alternating current signal received from the card reader to the power generation unit 300. The second antenna 120 is configured only to receive the power from the card reader, without being used in the wireless communication for data transmission.

According to one embodiment of the present invention, like this, the plurality of antennas 110 and 120 are connected to the smart card chip 200 in a state of being physically separated from each other, thereby improving the stability in the wireless communication between the smart card 10 and the card reader and increasing the amount of power received from the card reader.

The smart card chip 200 is activated by the radio frequency signal received from the first antenna 110. The smart card chip 200 includes a rectifier for rectifying the radio frequency signal received from the first antenna 110 into direct current power, a micro processor unit (MPU) having self-calculating functions, a read only memory (ROM) as a non-volatile memory in which a chip operation system (COS) is stored, an electrically erasable programmable read only memory (EEPROM) as a non-volatile memory in which an application program and data are stored, a random access memory (RAM) as a volatile memory in which data having different variables are temporarily stored, and an input/output interface for performing data exchange with the exterior thereof.

Further, the smart card chip 200 includes a secure element SE, and the secure element has universal integrated circuit card (UICC), embedded SE (eSE), and a microSD. The secure element has its own encryption system, and accordingly, information whose security is needed can be stored in the secure element.

The smart card chip 200 transmits and receives data to and from the external card reader through the first antenna 110 and controls operations of the application circuit unit 500 according to predetermined logics.

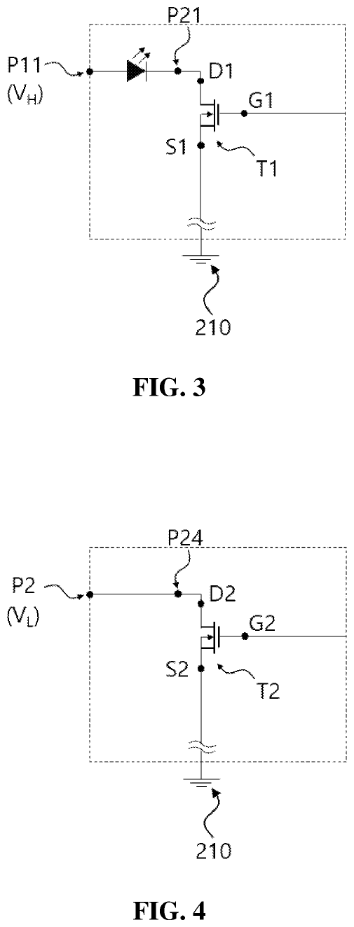

For example, the smart card chip 200 according to the present invention has a virtual ground terminal and is electrically connected to the application circuit unit 500 through a plurality of GPIO terminals to control the operations of the application circuit unit 500. A method for controlling the operations of the application circuit unit 500 through the smart card chip 200 will be explained later with reference to FIGS. 2 and 3.

According to other embodiments of the present invention, the smart card chip 200 may be controlled in the activation for the data communication with the external card reader by means of the application circuit unit 500.

The smart card chip 200 may use, as power, the radio frequency signal received through the first antenna 110, but the smart card chip 200 is electrically connected to the power generation unit 300 so that it operates with the power received therefrom.

The power generation unit 300 is disposed between the second antenna 120 and the application circuit unit 500 and converts the radio frequency signal received through the second antenna 120 into direct current power to supply the direct current power to the internal components of the smart card 10. The radio frequency signal received through the second antenna 120 is an alternating current signal, and accordingly, it has to be converted into the direct current power for operating the internal components of the smart card 10.

Accordingly, the power generation unit 300 can convert the radio frequency signal received through the second antenna 120 into the direct current power. For example, the power generation unit 300 is configured as a rectifying circuit using four diodes with bridge coupling, like a full-wave rectifier, but the power generation unit 300 according to the present invention may not be limited thereto.

The power storage unit 400 serves to store the direct current power generated from the power generation unit 300. For example, the power storage unit 400 may be a battery with a given capacity. Even if not shown in detail, further, the power storage unit 400 may further include power supply control means for receiving feedback of an output voltage of the power generation unit 300 and operation voltage levels of the application circuit unit 500 and the smart card chip 200 to control a time point for supplying the power stored therein.

The application circuit unit 500 operates with the direct current power generated from the power generation unit 300 and includes various application modules applied to the smart card 10. For example, the application circuit unit 500 includes a light emitting element such as a light emitting diode (LED), an organic light emitting diode (OLED), and the like, an acoustic element such as a speaker, and a passive element such as a vibration module. Hereinafter, an example in which the application circuit unit 500 has a plurality of light emitting elements will be given, but without being limited thereto, the application circuit unit 500 may include any one of various types of passive elements or a combination thereof.

The application circuit unit 500 is electrically connected to the power generation unit 300 and the smart card chip 200. For example, a high level power terminal P1 of the application circuit unit 500 is electrically connected to a high level power terminal P1 of the power generation unit 300, and low level power terminals P2 of the application circuit unit 500 and the power generation unit 300 are electrically connected to any one of the plurality of general-purpose input/output (GPIO) terminals of the smart card chip 200. Accordingly, the smart card chip 200 can control the passive elements of the application circuit unit 500 by means of the plurality of GPIO terminals. Hereinafter, the method for controlling the operations of the application circuit unit 500 through the smart card chip 200 will be explained with reference to FIGS. 2 and 3.

FIG. 2 is a schematic circuit diagram showing the application circuit unit of the smart card according to the present invention, and FIGS. 3 and 4 are schematic circuit diagrams showing the GPIO terminals of the smart card chip according to the present invention.

Referring to FIGS. 2 to 4, the application circuit unit 500 according to the present invention includes the plurality of light emitting elements. The plurality of light emitting elements include first to third LEDs LED1, LED2, and LED3. The high level power terminals P11, P12, and P13 of the first to third LEDs LED1, LED2, and LED3 are electrically connected to the high level power terminal P1 of the power generation unit 300, and the low level power terminals P21, P22, and P23 thereof are electrically connected to some of the plurality of GPIO terminals GPIO1, GPIO2, GPIO3, and GPIO4 of the smart card chip 200. Further, the low level power terminal P2 (or P24) of the power generation unit 300 is electrically connected to any one of the plurality of GPIO terminals GPIO1, GPIO2, GPIO3, and GPIO4 of the smart card chip 200.

For example, the smart card chip 200 includes four GPIO terminals GPIO1, GPIO2, GPIO3, and GPIO4. In this case, the low level power terminal P21 of the first LED LED1 is electrically connected to the first GPIO terminal GPIO1, the low level power terminal P22 of the second LED LED2 to the second GPIO terminal GPIO2, the low level power terminal P23 of the third LED LED3 to the third GPIO terminal GPIO3, and the low level power terminal P24 of the power generation unit 300 to the fourth GPIO terminal GPIO4.

The number of passive elements included in the application circuit unit 500 and the number of GPIO terminals included in the smart card chip 200 may not be limited to the above-mentioned embodiment, and accordingly, three passive elements or less or five GPIO terminals or more may be provided.

The plurality of GPIO terminals GPIO1, GPIO2, GPIO3, and GPIO4 of the smart card chip 200 are connected to drain terminals of transistors. That is, the smart card chip 200 includes the plurality of transistors corresponding to the plurality of GPIO terminals, and if the smart card chip 200 is not electrically connected to the application circuit unit 500, the transistors may be open-drain transistors whose drain terminals are open. The transistors include a plurality of first transistors T1 electrically connected to the plurality of passive elements (e.g., the first to third LEDs LED1, LED2, and LED3) of the application circuit unit 500 and a second transistor T2 electrically connected to the power generation unit 300.

Hereinafter, an explanation of the control of the smart card chip 200 for the operation of the first LED LED1 through the first GPIO terminal GPIO1 will be given with reference to FIGS. 3 and 4, but the control of the smart card chip 200 is performed in the same manner for the operations of the plurality of passive elements included in the application circuit unit 500 through the plurality of GPIO terminals.

The first to third GPIO terminals GPIO1, GPIO2, and GPIO3 connected to the first to third LEDs LED1, LED2, and LED3 are electrically connected to first drain terminals D1 of the first transistors T1 embedded in the smart card chip 200. First source terminals S1 of the first transistors T1 are electrically connected to a virtual ground terminal 210, and first gate terminals G1 are electrically connected to a control module (e.g., MPU) disposed in the interior of the smart card chip 200 to generate signals according to pre-stored logics.

Further, the fourth GPIO terminal GPIO4 connected to the power generation unit 300 is electrically connected to a second drain terminal D2 of the second transistor T2 embedded in the smart card chip 200, a second source terminal S2 of the second transistor T2 is electrically connected to the virtual ground terminal 210, and a second gate terminal G2 of the second transistor T2 is electrically connected to the control module disposed in the interior of the smart card chip 200 to generate the signals according to the pre-stored logics.

In this case, the virtual ground terminal 210 may be a ground terminal of the smart card chip 200. However, the virtual ground terminal 210 may be a separate terminal utilized as common grounding for controlling the operations of the application circuit unit 500, without being limited thereto, and under the control of the smart card chip 200, the virtual ground terminal 210 may be electrically connected or disconnected to and from the ground terminal of the smart card chip 200. That is, the virtual ground terminal 210 serves as a terminal for common grounding between the smart card chip 200 and the application circuit unit 500, thereby performing virtual common grounding for the radio frequency signal received from the external card reader.

If the smart card 10 is close to the external card reader to perform radio frequency communication with the card reader, the application circuit unit 500 receives the direct current power generated from the power generation unit 300 through the second antenna 120. In this case, the high level power terminal P11 of the first LED LED1 has the high level power voltage VH of the direct current power. The low level power terminal P21 of the first LED LED1 is connected to the first GPIO terminal GPIO1, and if no signal is applied to the first gate terminal G1 of the first transistor T1, the first transistor T1 is open so that no electric current flows.

Further, the smart card chip 200 is activated by the power received from the power generation unit 300 or the signal received from the external card reader through the first antenna 110 and applies a control signal (or a turn-on signal) to the first gate terminal G1 of the first transistor T1 according to the predetermined logics. Accordingly, the first transistor T1 is turned on to allow the electric current to flow to the first source terminal S1 from the first drain terminal D1, and a voltage of the low level power terminal P21 of the first LED LED1 becomes equal to that of the virtual ground terminal 210.

Even in the case, however, the voltage of the virtual ground terminal 210 is different from that of the low level power terminal P2 of the power generation unit 300, and so as to turn on the first LED LED1, accordingly, the low level power terminal P21 of the first LED LED1 has to be synchronized with the low level power voltage VL of the direct current power.

To do this, the smart card chip 200 applies a signal to the second gate terminal G2 so that the second transistor T2 connected to the low level power terminal P2 of the power generation unit 300 is turned on, and the voltage of the low level power terminal P2 of the power generation unit 300 and the voltage of the virtual ground terminal 210 are synchronized with the low level power voltage VL of the direct current power.

Accordingly, the voltage of the first source terminal S1 of the first transistor T1 is equal to the low level power voltage VL of the direct current power, so that the first LED LED1 becomes turned on.

Like this, the smart card chip 200 transmits the control signals to the gate terminals G1 and G2 of the plurality of transistors T1 and T2 connected to the plurality of GPIO terminals GPIO1, GPIO2, GPIO3, and GPIO4, thereby controlling the plurality of passive elements LED1. LED2, and LED3. Further, the common grounding is formed between the smart card chip 200 and the application circuit unit 500, and accordingly, the voltage levels between the power and signal line of the smart card chip 200 are equal to each other, thereby stabilizing the operating power of the application circuit unit 500 and the smart card chip 200.

The smart card chip 200 may operate the passive elements of the application circuit unit 500 through the plurality of GPIO terminals GPIO1, GPIO2, GPIO3, and GPIO4 in various methods. For example, if the smart card 10 comes into contact with (or is close to) the external card reader, the plurality of LED elements LED1, LED2, and LED3 may flicker, and otherwise, while payment using the smart card 10 is being carried out, the plurality of LED elements LED1, LED2, and LED3 may flicker sequentially. As a result, the operations of the smart card 10 are visually recognized by a user.

Further, if the application circuit unit 500 includes the speaker element (not shown), the smart card chip 200 operates to allow the operations of the smart card 10 to be audibly recognized by the user, and if the application circuit unit 500 includes the vibration module (not shown), the smart card chip 200 operates to allow the operations of the smart card 10 to be tangibly recognized by the user. The smart card 10 according to one embodiment of the present invention may be used advantageously to the user having visual or audible limitations in using his or her card.

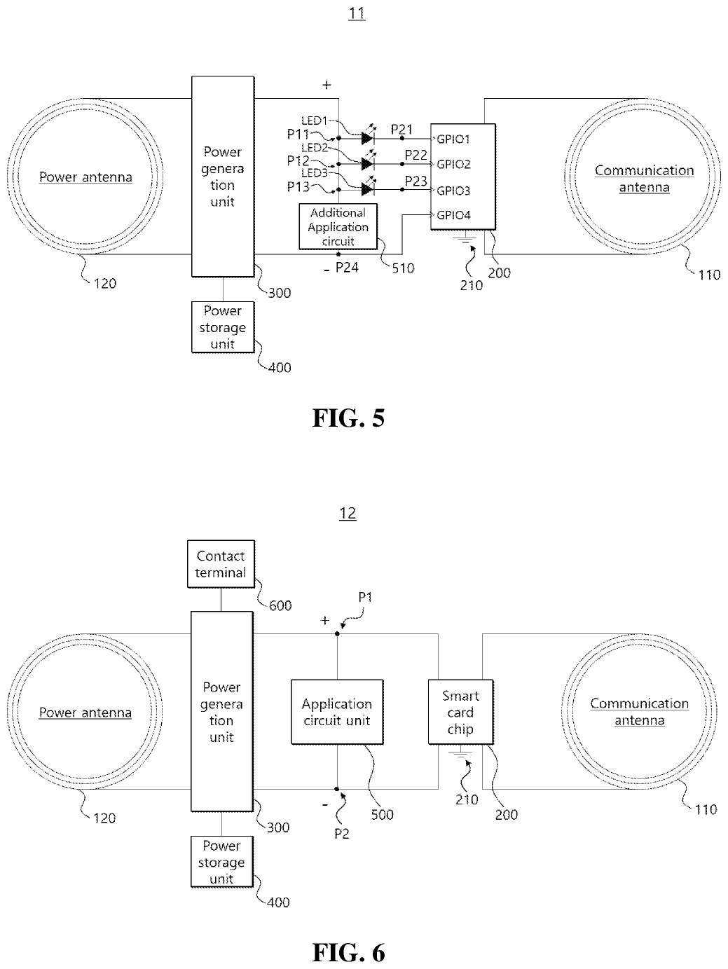

FIG. 5 is a schematic circuit diagram showing an application circuit unit of a smart card according to another embodiment of the present invention.

As shown in FIG. 5, in the case of a smart card 11 according to another embodiment of the present invention, the application circuit unit 500 further has an additional application circuit 510, which is different from the smart card 10 of FIG. 2.

The additional application circuit 510 includes a micro controller unit (MCU) with the form of a printed circuit or chip. The additional application circuit 510 operates various application modules added to the smart card 11. For example, if the smart card 11 further includes a display unit having various functions, such as a balance displaying function, a card operation (e.g., paying, payment completed, etc.) displaying function, and the like, the additional application circuit 510 has data exchange with the smart card chip 200 so as to control the functions of operating the display unit.

Even though not shown in detail, the additional application circuit 510 is electrically connected to other terminals of the smart card chip 200 except the plurality of GPIO terminals GPIO1, GPIO2, GPIO3, and GPIO4 of the smart card chip 200 for controlling the passive elements of the application circuit unit 500.

The additional application circuit 510 activates or deactivates the smart card chip 200. In this case, the activation and deactivation means the activation and deactivation in the wireless communication between the smart card chip 200 and the external card reader.

For example, wireless power charging (WPC) uses frequencies high in frequency domains, unlike data communication, and accordingly, the smart card chip 200 may be broken. As a result, if the wireless power charging using a wireless power charger for the smart card is performed, the additional application circuit 510 generates a deactivation signal for deactivating the smart card chip 200, so that the smart card chip 200 becomes deactivated.

Further, if the smart phone normally operates with the direct current power received from the power generation unit 300, the additional application circuit 510 generates and outputs an activation signal for activating the smart card chip 200, and if the activation signal is transferred to the smart card chip 200, the smart card chip 200 receives the direct current power from the power generation unit 300 and becomes activated.

Under the above-mentioned configuration, the smart card chip 200 is activated or deactivated by means of the additional application circuit 510, thereby preventing errors in the communication process between the application circuit unit 500 and the smart card chip 200 from occurring and performing effective synchronization therebetween.

FIG. 6 is a schematic circuit diagram showing a smart card according to yet another embodiment of the present invention.

As shown in FIG. 6, a smart card 12 according to yet another embodiment of the present invention further includes a contact terminal 600, which is different from the smart card 10 of FIG. 1. The contact terminal 600 comes into contact with the external card reader to receive power therefrom and simultaneously serves to provide data communication between the smart card chip 200 and the external card reader.

The contact terminal 600 receives the power from the external card reader and thus supplies the received power to the application circuit unit 500, the smart card chip 200, and even the power storage unit 400.

In the same manner as above, in this case, at least one passive element of the application circuit unit 500 is connected to the GPIO terminal of the smart card chip 200, and common grounding between the application circuit unit 500 and the smart card chip 200 is made by means of the virtual ground terminal 210, as described with reference to FIGS. 3 and 4.

The respective features of the embodiments of the present invention may be coupled or combined partially or entirely, and further, the respective parts of the embodiments of the present invention may freely interlockingly operate. Also, the embodiments of the present invention may be implemented independently of one another or combinedly with one another.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention. It should be noted that the use of particular terminology when describing certain features or aspect of the disclosure should not be taken to imply that the terminology is being re-defined herein to be restricted to include any specific characteristics of the features or aspects of the disclosure with which that terminology is associated. It is therefore intended that the scope of the invention be limited not by this detailed description, but rather by the claims appended hereto.

1. A smart card comprising:
a first and a second antennas performing wireless communication with a card reader;
a smart card chip electrically connected to the first antenna and performing the wireless communication with the card reader through the first antenna;
a power generation unit converting a frequency signal received through the second antenna to generate direct current power, and
an application circuit unit receiving the direct current power from the power generation unit and having at least one passive element operating under the control of the smart card chip,
wherein one end of the at least one passive element of the application circuit unit is electrically connected to the power generation unit and the other end thereof is electrically connected to any one of a plurality of GPIO terminals of the smart card chip.

2. The smart card according to claim 1, wherein a high level power terminal of the power generation unit is electrically connected to one end of the at least one passive element, and a low level power terminal of the power generation unit is electrically connected to another GPIO terminal.

3. The smart card according to claim 2, wherein the smart card chip comprises:
a plurality of transistors electrically connected to the plurality of GPIO terminals, and
a virtual ground terminal electrically connected to source terminals of the plurality of transistors.

4. The smart card according to claim 3, wherein the virtual ground terminal has a voltage equal to a voltage of the low level power terminal of the power generation unit under the control of the smart card chip.

5. The smart card according to claim 3, wherein drain terminals of the plurality of transistors are electrically connected to the plurality of GPIO terminals, and gate terminals of the plurality of transistors are electrically connected to a control module embedded in the smart card chip to generate control signals according to pre-stored logics.

6. The smart card according to claim 5, wherein the plurality of transistors are turned on by means of the control signals inputted to the gate terminals thereof.

7. The smart card according to claim 6, wherein the plurality of transistors comprise a first transistor electrically connected to the at least one passive element and a second transistor electrically connected to the power generation unit, and the at least one passive element operates if the first transistor and the second transistor are turned on.

8. The smart card according to claim 1, wherein the at least one passive element is at least one of a light emitting element, an acoustic element, and a vibration module.

9. The smart card according to claim 1, further comprising a power storage unit electrically connected to the power generation unit and storing the direct current power generated from the power generation unit.

10. The smart card according to claim 1, wherein the application circuit unit comprises an additional application circuit for generating an activation signal for activating the smart card chip.

11. The smart card according to claim 1, further comprising a contact terminal coming into contact with the card reader to receive power therefrom and allowing data communication between the smart card chip and the card reader.
